(19) United States
(12) Patent Application Publication
(10) Pub. No.: US 2017/0303578 A1
(43) Pub. Date: Oct. 26, 2017

(54) METHOD FOR OPERATING A FOOD PRINTER, AND ALSO ASSOCIATED FOOD PRINTER AND ASSOCIATED DOMESTIC APPLIANCE

(71) Applicant: BSH HAUSGERÄTE GMBH, München (DE)

(72) Inventor: Andreas SCHÜSSLER, München (DE)

(21) Appl. No.: 15/517,634

(22) PCT Filed: Oct. 13, 2015
(86) PCT No.: PCT/EP2015/073629

§ 371 Date: Apr. 7, 2017

(30) Foreign Application Priority Data
Oct. 16, 2014 (DE) 10 2014 220 954.4

(51) Int. Cl. A23P 30/20; B33Y 50/02; B33Y 40/00; B33Y 30/00; F25D 23/12; B33Y 10/00

(52) U.S. Cl. CPC A23P 30/20; B33Y 50/02; B33Y 10/00; B33Y 30/00; F25D 23/12; B33Y 40/00

(57) ABSTRACT

The invention relates to a method for operating a food printer, and also to a food printer having a mounting apparatus which is designed to mount the food printer in a treatment compartment of a domestic appliance, in particular in a cooking compartment of a domestic oven and/or in a refrigeration compartment of a domestic refrigerator, and the invention relates to a domestic appliance, in particular a domestic oven and/or a domestic refrigerator, having an electrical interface which is designed to electrically connect a food printer of this kind to the domestic appliance, in particular to the domestic oven and/or to the domestic refrigerator, and/or to actuate said food printer.

The invention relates to a method for operating a food printer, and also to a food printer, having a mounting apparatus, which is designed to mount the food printer in a treatment compartment of a domestic appliance, in particular in a cooking compartment of a domestic oven and/or in a refrigeration compartment of a domestic refrigerator, and the invention relates to a domestic appliance, in particular to a domestic oven and/or a domestic refrigerator, having an electrical interface, which is designed to electrically connect a food printer of this kind to the domestic appliance, in particular to the domestic oven and/or to the domestic refrigerator, and/or to actuate said food printer.

U.S. Pat. No. 6,280,785 B1 describes a method for fabricating three-dimensional food products. A corresponding apparatus, the food printer, has a movable nozzle controlled in one plane, from which a liquid to paste-like food mass is dispensed in a controlled manner onto a support member, so that a three-dimensional food product can be built up layer by layer. The food printer in this invention has an electronic control apparatus, which activates the nozzle in accordance with a computer-generated shape template.

WO 2010/151202 A1 describes a kitchen device in the form of a food printer, having a tubular housing with an upper opening, via which a food mass and binding agents can be supplied. Arranged in a lower area of the housing is a controllable movable nozzle, via which the food mass and the binding agent emerge drop-by-drop and form layers lying on top of one another in order to build up a three-dimensional food product.

The object of the invention is to create a method for operating a food printer, and also an associated food printer and an associated domestic appliance, through which high-quality three-dimensional food products can be fabricated.

The object of the invention is achieved by a method for operating a food printer, having the following steps:
Provision of a domestic appliance, which is embodied for treating, especially for warming up, heating, cooling and/or freezing of food and which has a treatment compartment for food configured for this purpose.
Equipping the food printer with a food mass to be treated,
Positioning the food printer in the treatment compartment of the domestic appliance
Pre-shaping of a food product from the food mass by the food printer in the treatment compartment,
Operation of the domestic appliance for treating the food mass and/or the food product during and/or after the food product will be/is pre-shaped from the food mass by the food printer in the treatment compartment of the domestic appliance.

A food printer, which is also referred to inter alia as a 3D food printer, is an apparatus which, in its basic design, is similar to a computer printer, but does not provide any ink or toner or paper however, but deposits food masses on a lower support, such as a plate or a baking sheet for example. In such cases a pre-specified amount of a food mass will be dispensed from a nozzle automatically per unit of time and the dispensing nozzle will be moved around automatically within a plane, so that three-dimensional bodies will be built up step-by-step from the food. These layers can be constructed under computer control in accordance with a three-dimensional template stored in a computer. The amount supplied per unit of time through the dispensing nozzle and the movement of the dispensing nozzle within the plane will be controlled automatically by a control apparatus of the food printer. The food mass conveyed through the dispensing nozzle can be a liquid, a paste and/or a solid, for example in the form of a powder or a melt. For controlling and setting the aggregate state of the food mass and/or its viscosity the food mass can be warmed up or cooled down.

Food printers as such are known, which can be operated as self-contained devices. In accordance with the invention there is especially provision, among other aspects, for an inventive food printer to be fitted into a treatment compartment of another domestic appliance, especially into a cooking compartment of a domestic oven and/or into a refrigeration compartment of a domestic refrigerator, and to be operated therein. Such functionalities of the domestic appliance already present, especially of the domestic oven and/or of the domestic refrigerator, can be used in such cases to influence physically, especially to influence thermally, i.e. to heat up, to cool down or the treat by means of microwave or heat radiation the food mass treated by the food printer, especially conveyed by it. This especially enables the structure of the food layers to be influenced during or shortly after they have been produced.

The domestic appliance can accordingly be a domestic oven, especially an electric domestic oven and the food mass and/or the food product can in such cases be warmed up by the domestic oven to a heating temperature lying below the cooking temperature of the food product.

The food mass can in such cases be stored in a storage compartment cooled to below the heating temperature and/or below the cooking temperature, especially a cooled storage compartment of the food printer. By the food mass being stored in a storage compartment cooled to below the heating temperature and/or below the cooking temperature, at least essentially only the food mass emerging from the dispensing nozzle and not the base mass stored in the storage compartment will be influenced by the operation of the domestic appliance, especially of the domestic oven.

A number of different food masses can be provided in the food printer. Each type of food mass can be contained in a cartridge for example. A number of cartridges can form a magazine in the storage compartment. The storage compartment can be provided with a cover, which can be opened and closed. In an open position of the cover the cartridges can be exchanged, i.e. empty cartridges removed and full cartridges inserted. In a closed position of the cover the storage compartment can be thermally insulated from the environment of the food printer, especially thermally insulated from a cooking compartment of the domestic oven.

In an alternate form of embodiment the domestic appliance can be a domestic refrigerator and the food mass and/or the food product can be cooled by the domestic refrigerator to a refrigeration temperature and/or a freezing temperature lying below the ambient temperature.

The food mass in such cases can be stored in a storage compartment heated to above the freezing temperature and/or the refrigeration temperature, especially above the ambient temperature, especially a heated storage compartment of the food printer. By the food mass being stored in a storage compartment heated to above the freezing temperature and/or the refrigeration temperature, at least essentially only the food mass emerging from the dispensing nozzle and not the base mass stored in the storage compartment will be influenced by the operation of the domestic appliance, especially of the domestic refrigerator. The domestic refrigerator can be a refrigerator, a freezer and/or a fridge/freezer combination. Accordingly the refrigerator compartment can also be a freezer compartment.

In a development of the invention the food printer can have a mounting apparatus, which is embodied to mount the food printer in a treatment compartment of a domestic appliance, in particular in the cooking compartment of the domestic oven and/or in the refrigeration compartment of the domestic refrigerator.

The mounting apparatus can be embodied on a housing of the food printer. In particular the mounting apparatus can be fastened to one or more outer walls of the housing of the food printer or be embodied in one piece with said housing.

In one design variant the mounting apparatus can be embodied so as to mount the food printer in the cooking compartment of the domestic oven on bearer means lying opposite one another on the sides of a domestic oven, which are embodied to receive baking sheets and/or slide-in oven shelves.

The mounting apparatus can thus be embodied for example for mounting the food printer in a cooking compartment of the domestic oven on bearer means of the domestic oven lying opposite one another on its sides. The bearer means lying opposite one another on the sides of the domestic oven can be formed by bearer means known per se, which are embodied in accordance with the prior art for receiving baking sheets and/or slide-in oven shelves. The bearer means can for example be grooves embodied on opposite vertical side walls of the cooking compartment. As an alternative the bearer means can be formed by separate brackets projecting into the cooking compartment, which are fastened as separate components to the opposite vertical side walls of the cooking compartment.

The mounting apparatus can be formed by rails for example, which are arranged on opposite side walls of the housing. The rails can be embodied in such cases to be attached to the bearer means of the domestic oven, in particular pushed into the grooves or pushed onto the brackets. The mounting apparatus thus makes it possible to push the food printer into the cooking compartment in a similar way to baking sheet and/or slide-in oven shelf. In a position of the food printer pushed into the cooking compartment a cooking compartment door of the domestic oven can be closed, so that the domestic oven can be operated in a manner known per se.

The mounting apparatus can be embodied in another design variant to mount the food printer in a refrigeration compartment of a domestic refrigerator on bearer means lying opposite one another on sides of the domestic refrigerator, which are embodied for receiving refrigerated goods shelves and/or freezer drawers.

As an alternative or in addition the mounting apparatus can however also be embodied for mounting the food printer in a refrigeration compartment of a domestic refrigerator on bearer means lying opposite one another on the sides of the domestic refrigerator. The bearer means lying opposite one another on sides the domestic refrigerator can be formed by bearer means known per se, which are embodied in accordance with the prior art for accepting shelves and/or glass plates. The bearer means can for example be grooves embodied on the inner container on opposite vertical side walls of the refrigeration compartment.

The mounting apparatus can also be formed here by rails, which are arranged on opposite side walls of the housing. The rails can be embodied in such cases to be attached to the bearer means of the domestic refrigerator, in particular pushed into the grooves. The mounting apparatus thus makes it possible to push the food printer into the refrigeration compartment of the domestic refrigerator in a similar way to a shelf and/or glass plate. In a position of the food printer pushed into the refrigeration compartment a refrigeration compartment door of the domestic refrigerator can be closed, so that the domestic refrigerator can be operated in a manner known per se.

In all embodiment variants the food printer can have a heating device and/or a cooling device, as well as a storage compartment for food mass coupled thermally to the heating device and/or the cooling device.

In the case of an exemplary embodiment the food printer has cooling device, as well as a storage compartment for food mass coupled thermally to the cooling device. A number of different food masses can be provided. Each type of food mass can be contained in a cartridge. A number of cartridges, for example four, can form a magazine in the storage compartment. The storage compartment can be provided with a cover that can be opened and closed. In an open position of the cover the cartridges can be exchanged, i.e. empty cartridges removed and full cartridges inserted. In a closed position of the cover the storage compartment can also be insulated thermally from the environment of the food printer. The storage compartment able to be closed by means of the cover, which can be cooled by the cooling device, enables the food mass, in particular the cartridges, to be stored cooled to below the heating temperature and/or to below the cooking temperature in the storage compartment.

Accordingly the invention further relates to a food printer as described, having a stand facility that is embodied to let the food printer, especially a housing that has the food printer, stand on a surface at such a distance from it that a dispensing nozzle which has the food printer remains at a distance from said surface and/or is untouched. The stand facility can be formed by bracket-like feet for example, which extend along two opposing lower side edges of the housing of the food printer. The stand facility, especially the bracket-like feet, can extend in parallel to the rails in this case.

In all embodiment variants the food printer can be embodied and/or configured in particular to have a control apparatus, which is embodied and/or configured to carry out a method as described.

The invention also relates to a domestic appliance, in particular a domestic oven and/or domestic refrigerator, having an electrical interface, which is embodied for electrical connection of a food printer, as described here, to the domestic appliance, in particular the domestic oven and/or the domestic refrigerator, such that, when located in an operating position in the treatment compartment, the food printer is supplied with electrical energy for operating the food printer via the domestic appliance, in particular via the domestic oven and/or the domestic refrigerator and/or such that, when located in an operating position in the treatment compartment, the food printer is controlled via the domestic oven and/or the domestic refrigerator, especially via its respective device controller.

A concrete exemplary embodiment of an inventive food printer is explained in greater detail in the description given below, which refers to the enclosed figures. Concrete features of this exemplary embodiment, regardless of the context in which they are mentioned, possibly also considered individually or in combination, represent general features of the invention.

In the figures:

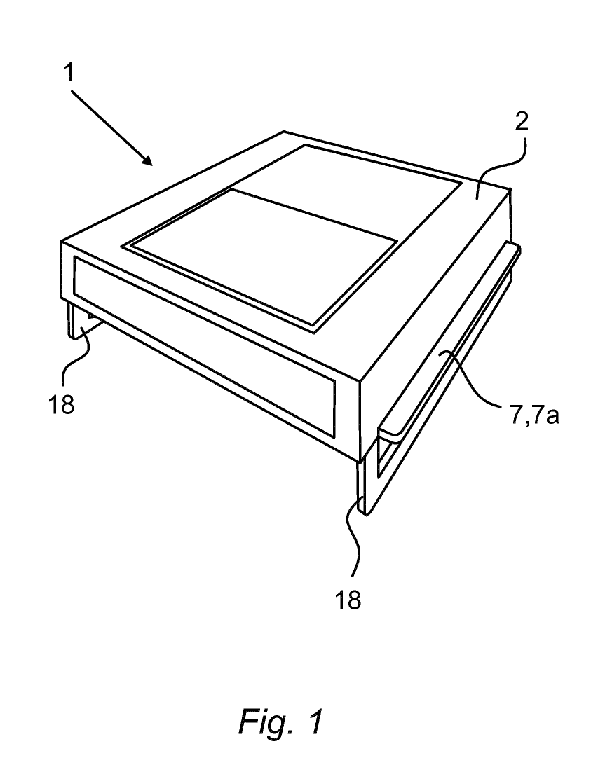

FIG. 1 shows a perspective schematic diagram of an example of an inventive food printer,

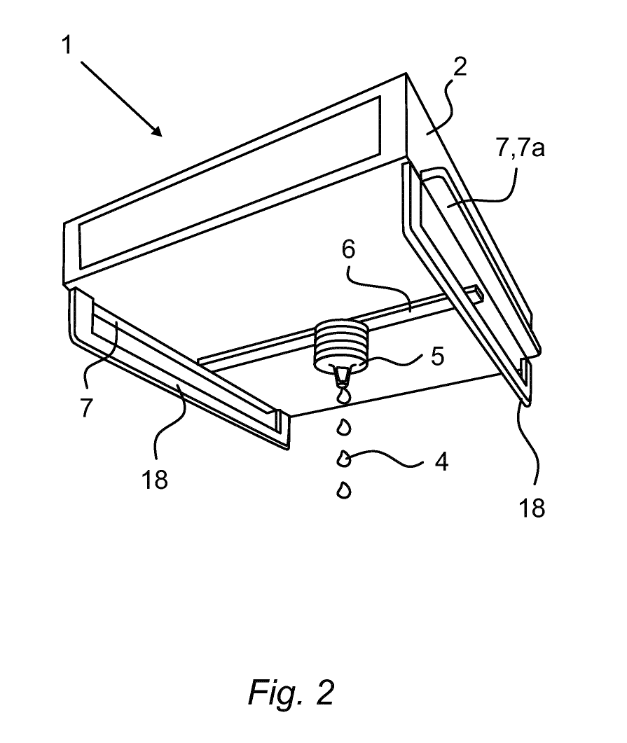

FIG. 2 shows a perspective schematic diagram of the food printer in accordance with FIG. 1 seen from below, with a view of a food dispensing nozzle and an inventive mounting apparatus,

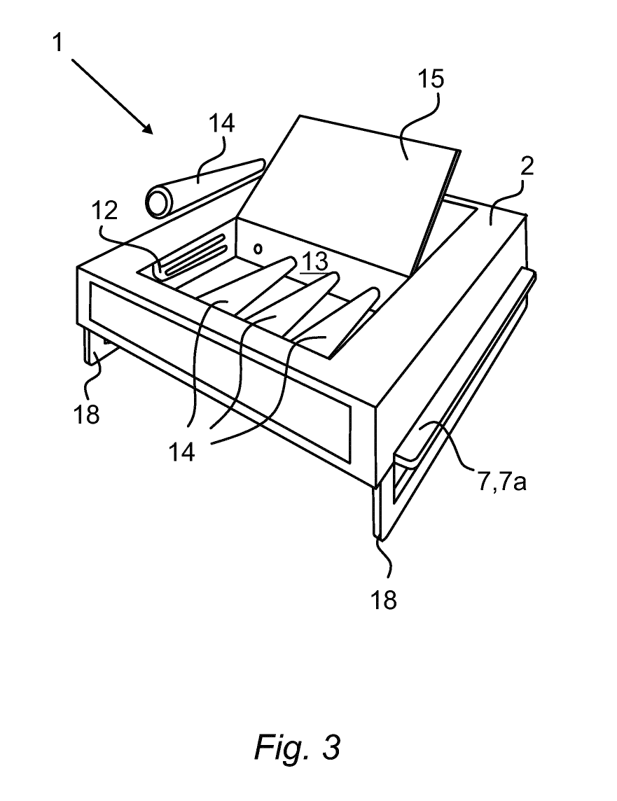

FIG. 3 shows a perspective schematic diagram of the food printer in accordance with FIG. 1, with an inventive storage compartment shown opened,

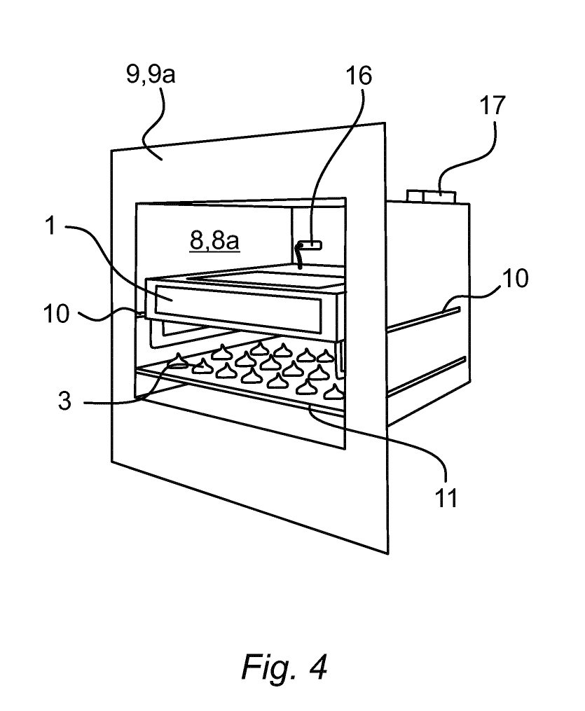

FIG. 4 shows a perspective schematic diagram of a domestic oven, which has bearer means on which the food printer in accordance with FIG. 1 is mounted by means of its mounting apparatus within the cooking compartment of the domestic oven; and

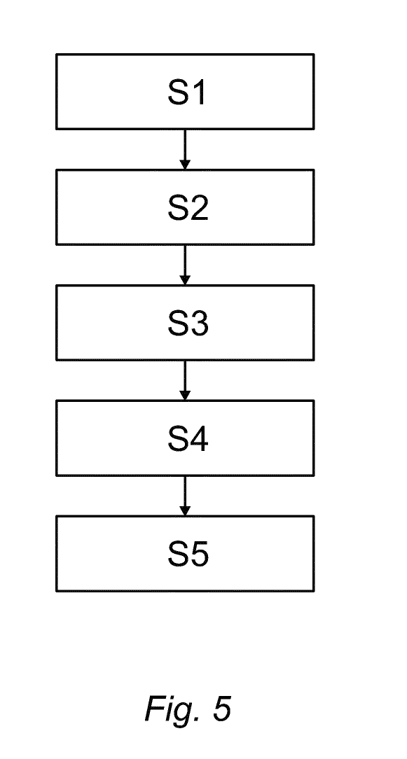

FIG. 5 shows an example of flowchart of an inventive method sequence.

A food printer 1 shown schematically in FIG. 1 has a housing 2. The food printer 1, in respect of its basic function of printing of food products 3 (FIG. 4) from a food mass 4 (FIG. 2), is embodied in a way known to the person skilled in the art. To this end the food printer 1 has inter alia a dispensing nozzle 5 (FIG. 2), which is embodied to convey the food mass 4 outwards in a controlled manner, in order to form the food product 3. The dispensing nozzle 5 is freely adjustable in one plane, actuated by means of an adjustment apparatus 6.

The food printer 1 has an inventive mounting apparatus 7. In the case of the present exemplary embodiment the mounting apparatus 7 is embodied for mounting the food printer 1 in a treatment compartment 8 (FIG. 4) of a domestic appliance 9, in particular in a cooking compartment 8a of a domestic oven 9a. The mounting apparatus 7 can, as shown, be embodied on the housing 2. In particular the mounting apparatus 7 is fastened to one or more outer walls of the housing 2 or embodied in one piece with said walls.

The mounting apparatus 7 is embodied for mounting the food printer 1 in the cooking compartment 8a of the domestic oven 9a on laterally opposite bearer means 10 of the domestic oven 9a. The laterally opposite bearer means 10 of the domestic oven 9a can be formed by bearer means 10 known per se, which, in accordance with the prior art, are embodied for receiving baking sheets 11 (FIG. 4) and/or slide-in oven shelves. The bearer means 10 can for example be grooves embodied on opposite vertical side walls of the cooking compartment 8a. As an alternative the bearer means 10 can be formed by separate brackets projecting into the cooking compartment 8a, which are attached as separate components to the opposite vertical side walls of the cooking compartment 8a.

The mounting apparatus 7 can, as shown, be formed by two rails 7a, which are arranged on opposite side walls of the housing 2. The rails 7a are embodied in this case to be attached to the bearer means 10 of the domestic oven 9a, in particular pushed into the grooves or pushed onto the brackets. The mounting apparatus 7 thus makes it possible to push the food printer 1 into the cooking compartment 8a like a baking sheet 11 (FIG. 4) or a slide-in oven shelf. Once the food printer 1 is in its position pushed into the cooking compartment 8a, a cooking compartment door (not shown) of the domestic oven 9a can be closed, so that the domestic oven 9a can be operated in a way known per se.

In the case of the present exemplary embodiment of the domestic oven 9a the food printer 1 has a cooling facility 12, as well as a storage compartment 13 coupled thermally to the cooling facility 12 for the food mass 4. A number of different food masses 4 can be provided. Each type of food mass 4 can be contained in a cartridge 14. The number of cartridges 14, in the present exemplary embodiment four cartridges, form a magazine in the storage compartment 13. The storage compartment 13 is provided with a cover 15, which can be opened and closed. In an open position of the cover 15 the cartridges 14 can be exchanged, i.e. empty cartridges can be removed and full cartridges inserted. In a closed position of the cover 15 the storage compartment 13 is also thermally insulated from the environment of the food printer 1, in particular is thermally insulated from the cooking compartment 8a.

The storage compartment 13, which can be cooled by the cooling facility 12 able to be closed by means of the cover 15, enables the food mass 4, in particular enables the cartridges 14 to be stored cooled in the storage compartment 13 to below the heating temperature and/or to below the cooking temperature.

When the food mass 4 then emerges from the dispensing nozzle 5 and/or the food product 3 has been applied to the baking sheet 11 for example, this food mass 4 and/or the food product 3 can initially be heated up to a heating temperature lying below the cooking temperature of the food product 3 by means of the domestic oven.

Accordingly FIG. 4 shows a domestic appliance 9, in particular a domestic oven 9a in the case of the present exemplary embodiment. The domestic appliance 9 or the domestic oven 9a has an electrical interface 16, which is embodied for electrical connection of the food printer 1 to the domestic appliance 9, in particular the domestic oven 9a, such that, when located in an operating position in the treatment compartment 8, i.e. the cooking compartment 8a, as shown, the food printer 1 is supplied with electrical energy for operating the food printer 1 via the domestic appliance 9, in particular via the domestic oven 9a and/or such that, when located in an operating position in the treatment compartment 8, the food printer 1 is controlled via the domestic oven 9a, especially via its respective device controller 17.

In the exemplary embodiment shown in FIG. 1 to FIG. 4 the food printer 1 also has a stand facility 18, which is embodied to place the food printer 1, in particular the housing 2, at such a distance from a surface on which it is standing that the dispensing nozzle 5 is spaced away from the surface and/or remains untouched. The stand facility 18 is formed in the present exemplary embodiment by two bracket-like feet, which extend along two opposite lower side edges of the housing 2. The stand facility 18, especially the two bracket-like feet, extend in parallel to the rails 7a in this case.

FIG. 5 shows a schematic diagram of an example of a flowchart of an inventive method sequence.

In the method for operating the food printer 1, in a first step S1, a domestic appliance 9 is provided, which is embodied for treating, in particular for warming up, heating, cooling and/or freezing of food and which has a treatment compartment 8 for food configured for this purpose.

In a second step S2 the food printer 1 is equipped with a food mass 4 to be treated.

Subsequently, in step S3, the food printer is positioned in the treatment compartment 8 of the domestic appliance 9.

Now, in step S4, a food product 3 is pre-shaped from the food mass 4 by the food printer 1 in the treatment compartment 8.

The domestic appliance 9 is already being operated during step S4 or after step S4 for treating the food mass 4 and/or the food product 3 while and/or after the food product 3 will be/is being pre-shaped from the food mass 4 by the food printer 1 in the treatment compartment 8 of the domestic appliance 9.

### LIST OF REFERENCE CHARACTERS

1 Food printer
2 Housing
3 Food product
4 Food mass
5 Dispensing nozzle
6 Adjustment apparatus
7 Mounting apparatus
7a Rails
8 Treatment compartment
8a Cooking compartment
9 Domestic appliance
9a Domestic oven
10 Bearer means
11 Baking sheet
12 Cooling facility
13 Storage compartment
14 Cartridge
15 Cover
16 Electrical interface
17 Device controller
18 Stand facility

1. A method for operating a food printer (1), having the following steps:
Provision of a domestic appliance (9), which is embodied for treating, especially for warming up, heating, cooling and/or freezing of food and which has the treatment compartment (8) for food configured for this purpose.
Equipping the food printer (1) with a food mass (4) to be treated,
Positioning the food printer (1) in the treatment compartment (8) of the domestic appliance (9),
Pre-shaping of a food product (3) from the food mass (4) by the food printer (1) in the treatment compartment (8),
Operation of the domestic appliance (9) for treating the food mass (4) and/or the food product (3) during and/or after the food product (3) will be/is pre-shaped from the food mass (4) by the food printer (1) in the treatment compartment (8) of the domestic appliance (9).

2. The method as claimed in claim 1, characterized in that the domestic appliance (9) is a domestic oven (9a), in particular an electric domestic oven (9a) and the food mass (4) and/or the food product (3) will be heated up by the domestic oven (9a) to a heating temperature lying below the cooking temperature of the food product (3).

3. The method as claimed in claim 2, characterized in that the food mass (4) will be stored in a storage compartment (13) cooled to below the heating temperature and/or to below the cooking temperature, in particular a cooled storage compartment (13) of the food printer (1).

4. The method as claimed in claim 1, characterized in that the domestic appliance (9) is a domestic refrigerator and the food mass (4) and/or the food product (3) will be cooled by the domestic refrigerator to a cooling temperature and/or freezing temperature lying below the ambient temperature.

5. The method as claimed in claim 4, characterized in that the food mass (4) will be stored in a storage compartment (13) heated to above the freezing temperature and/or the cooling temperature, especially to above the ambient temperature, especially in a heated storage compartment (13) of the food printer (1).

6. A food printer (1) having a mounting apparatus (7), which is embodied for mounting the food printer (1) in a treatment compartment (8) of a domestic appliance (9), especially in a cooking compartment (8a) of a domestic oven (9a) and/or in a refrigeration compartment of a domestic refrigerator.

7. The food printer as claimed in claim 6, characterized in that the mounting apparatus (7) is embodied for mounting the food printer (1) in the cooking compartment (8a) of the domestic oven (9a) on laterally opposite bearer means (10) of the domestic oven (9a), which are embodied for receiving baking sheets (11) and/or slide-in oven shelves.

8. The food printer as claimed in claim 6 or 7, characterized in that the mounting apparatus (7) is embodied for mounting the food printer (1) in the refrigeration compartment of the domestic refrigerator on laterally opposite bearer means (10) of the domestic refrigerator, which are embodied for receiving refrigerated goods shelves and/or freezer drawers.

9. The food printer as claimed in one of claims 6 to 8, characterized in that the food printer (1) has a heating device and/or a cooling device (12) as well as a storage compartment (13) for food mass (4) thermally coupled to the heating device and/or the cooling device (12).

10. The food printer as claimed in one of claims 6 to 9, having a stand facility (18), which is embodied to place the food printer (1), especially a housing (2) that has the food printer (1), at a distance from a surface on which it is standing such that a dispensing nozzle (5) that has the food printer (1), is spaced at a distance from the surface and/or remains untouched.

11. The food printer as claimed in one of claims 6 to 10, which is embodied and/or configured, in particular has a control facility, which is embodied and/or configured to a carry out a method as claimed in one claims 1 to 5.

12. A domestic appliance, in particular a domestic oven (9a) and/or domestic refrigerator, having an electrical interface (16), which is embodied to connect a food printer (1), as claimed in one of claims 6 to 11, electrically to the domestic appliance (9), in particular to the domestic oven (9a) and/or to the domestic refrigerator, such that, when located in an operating position in the treatment compartment (8), the food printer (1) is supplied with electrical energy for operating the food printer (1) via the domestic appliance (9), in particular via the domestic oven (9a) and/or via the domestic refrigeration device and/or such that, when located in an operating position in the treatment compartment (8), the food printer (1) is controlled via the domestic oven (9a) and/or via the domestic refrigerator, especially via its respective device controller (17).
